(19) United States
(12) Patent Application Publication
(10) Pub. No.: US 2009/0040185 A1
(43) Pub. Date: Feb. 12, 2009

(54) ANTENNA MODULE FOR A DISPLAY DEVICE THAT INCORPORATES AN ELECTROMAGNETIC DIGITIZING TABLET FUNCTION

(76) Inventor: Huo-Lu TSAI, Taichung Hsien (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/834,071

(22) Filed: Aug. 6, 2007

(51) Int. Cl. G06F 3/041

(52) U.S. Cl. 345/173

(57) ABSTRACT

An antenna module includes a dielectric substrate, x-axis and y-axis antennas, a plurality of contact units, and an interconnecting unit. The dielectric substrate has opposite first and second surfaces. Each of the x-axis and y-axis antennas is formed an a respective one of the first and second surfaces of the dielectric substrate. Each of the contact units is formed on the first surface of the dielectric substrate. The interconnecting unit interconnects the contact units.

### BACKGROUND OF THE INVENTION

1. Field of the Invention

This invention relates to an antenna module, more particularly to an antenna module for a display device that incorporates an electromagnetic digitizing tablet function.

2. Description of the Related Art

FIG. 1 illustrates a conventional display device that incorporates an electromagnetic digitizing tablet function, and that includes a liquid crystal display (LCD) panel 11, an antenna module 13, a control circuit (not shown), and a backlight module 12. The antenna module 13 is implemented with the use of a printed circuit board (PCB), includes X-axis and y-axis antennas, and is disposed behind the LCD panel 11 for detecting magnetic fields from an electromagnetic pen 14 when the electromagnetic pen 14 makes a point contact with a surface of the LCD panel 11. The control circuit is mounted on the LCD panel 11, and is operable so as to translate the detected magnetic fields into coordinates of the electromagnetic pen 14. The backlight module 12 is disposed between the LCD panel 11 and the antenna module 13, and includes a pair of cold cathode fluorescent lamps (CCFLs) 121, and a light transmissible board 122 sandwiched between the CCFLs 121.

With further reference to FIG. 2, while display devices of the foregoing type are acceptable, it is, nevertheless, desirable to replace the CCFLs 121 with light-emitting diodes (LEDs) 123. This, however, can cause a problem. Particularly, since an LED circuit board 124, on which the LEDs 123 are mounted, is disposed between the LCD panel 11 and the antenna module 13, the LED circuit board 124 undesirably distorts the magnetic fields from the electromagnetic pen 14. Hence, the control circuit of the conventional display device may not be able to operate accurately.

### SUMMARY OF THE INVENTION

Therefore, the present invention is to provide an antenna module that can overcome the aforesaid drawbacks of the prior art.

According to the present invention, an antenna module for a display device that incorporates an electromagnetic digitizing tablet function comprises a dielectric substrate, x-axis and y-axis antennas, a plurality of contact units, and an interconnecting unit. The dielectric substrate has opposite first and second surfaces Each of the x-axis and y-axis antennas is formed on a respective one of the first and second surfaces of the dielectric substrate. The x-axis antenna includes a plurality of parallel antenna traces, each of which extends in a first direction. The first surface of the dielectric substrate defines a plurality of regions, each of which is bounded by an adjacent pair of the antenna traces of the x-axis antenna. The y-axis antenna includes a plurality of parallel antenna traces, each of which extends in a second direction transverse to the first direction. Each of the contact units is formed on the first surface of the dielectric substrate, is disposed within a respective one of the regions, and includes an array of first contacts and an array of second contacts. The interconnecting unit is formed on the first surface of the dielectric substrate, and includes a plurality of first interconnecting lines, each of which interconnects the first contacts of a respective one of the contact units, and a plurality of second interconnecting lines, each of which interconnects the second contacts of the respective one of the contacts units.

### BRIEF DESCRIPTION OF THE DRAWINGS

Other features and advantages of the present invention will become apparent in the following detailed description of the preferred embodiment with reference to the accompanying drawings, of which;

FIG. 1 is a schematic view of a conventional display device;

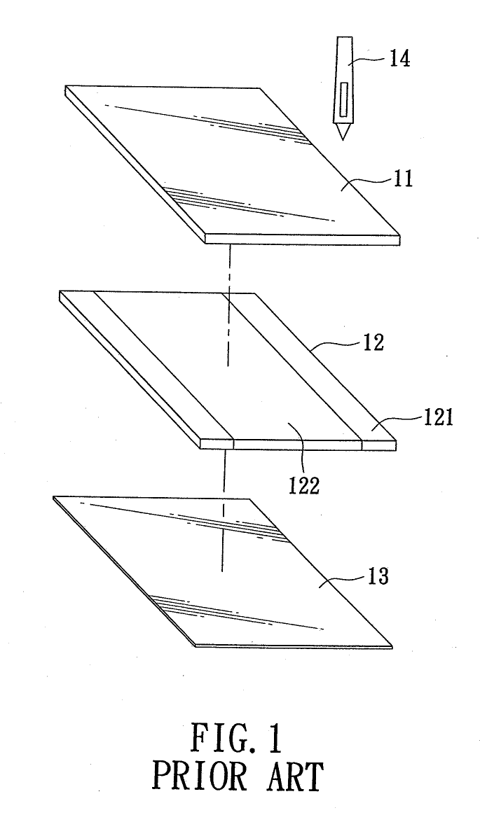

FIG. 2 is a schematic view of another conventional display device;

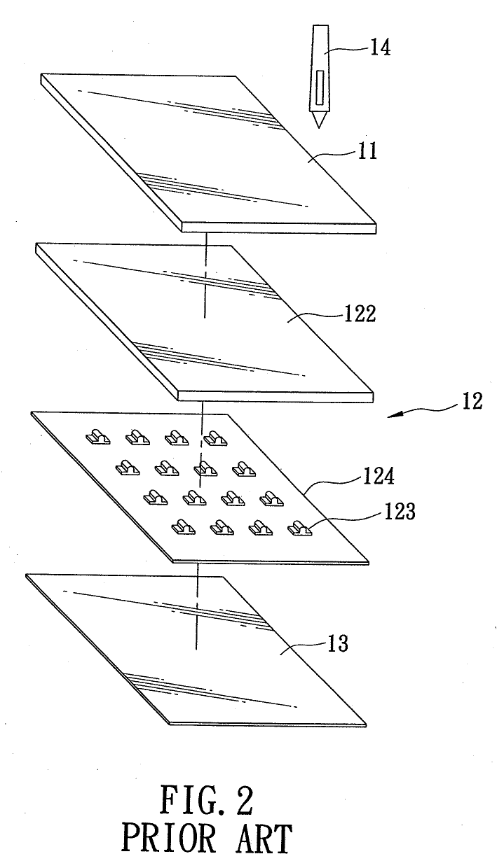

FIG. 3 is a schematic view of the preferred embodiment of an antenna module according to this invention;

FIG. 4 is a schematic view illustrating the preferred embodiment mounted on a display device;

FIG. 5 is a fragmentary sectional view to illustrate an electromagnetic interference shield of the preferred embodiment;

FIG. 6 is a schematic view illustrating an x-axis antenna of an antenna unit of the preferred embodiment; and

FIG. 7 is a schematic view illustrating a y-axis antenna of an antenna unit of the preferred embodiment.

### DETAILED DESCRIPTION OF THE PREFERRED EMBODIMENT

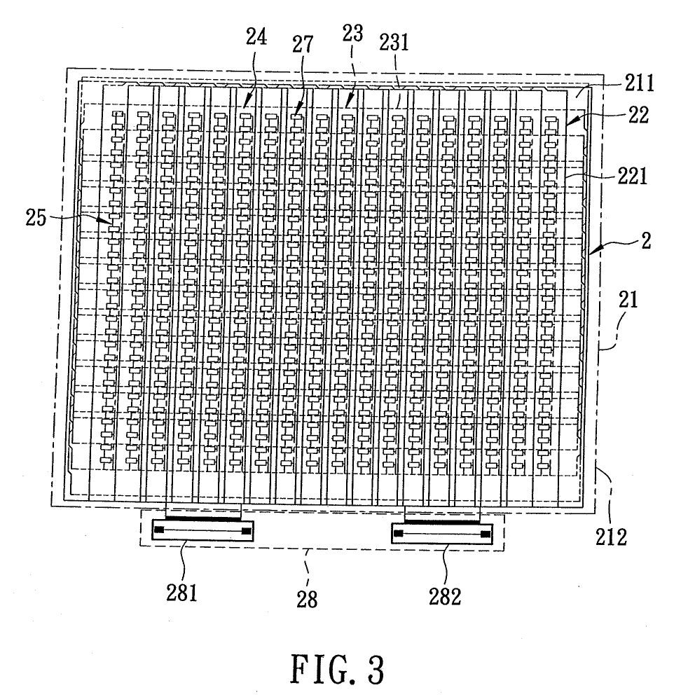

Referring to FIG. 3, the preferred embodiment of an antenna module 2 according to this invention is shown to include a dielectric substrate 21, x-axis and y-axis antennas 22, 23, a plurality of contact units 24, and an interconnecting unit 25.

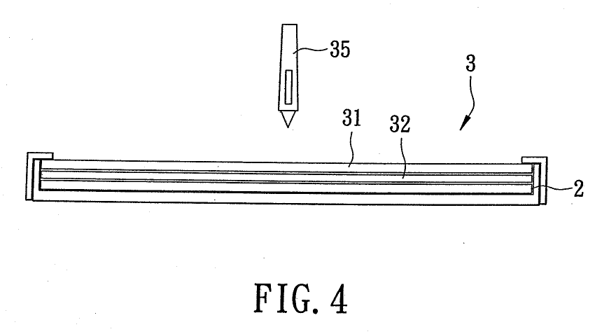

The antenna module 2 of this invention is applied to a display device 3 (see FIG. 4) that incorporates an electromagnetic digitizing tablet function.

With further reference to FIG. 4, the antenna module 2 is disposed behind a liquid crystal display (LCD) panel 31 of the display device 3. The display device 3 includes a light transmissible board 32 disposed between the LCD panel 31 and the antenna module 2.

The dielectric substrate 21 has opposite first and second surfaces 211, 212.

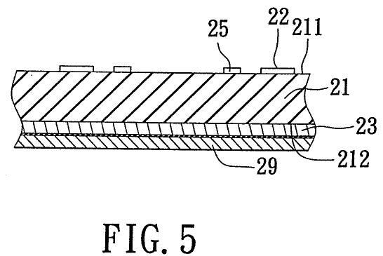

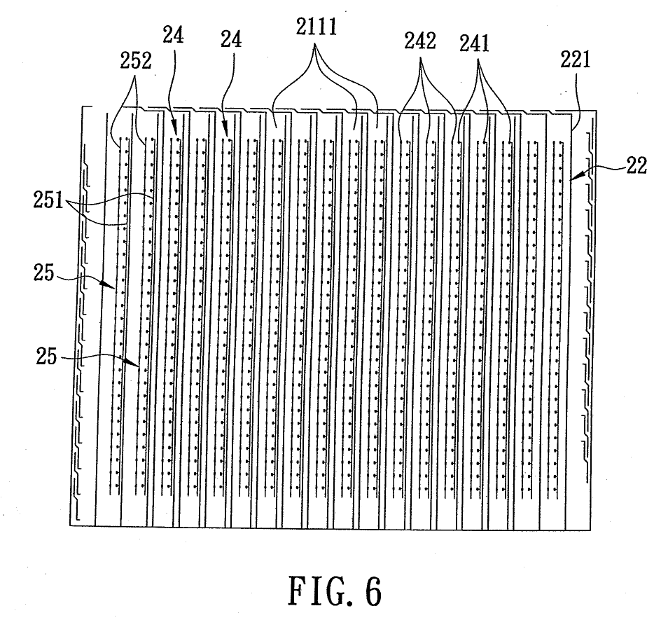

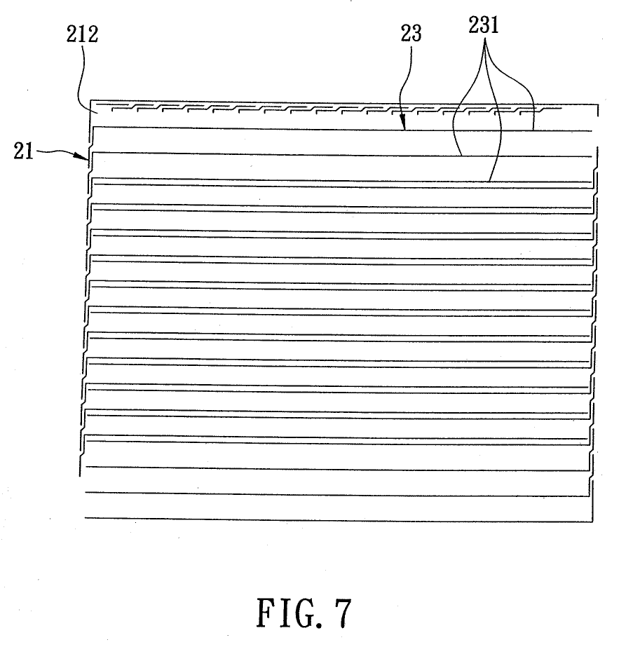

With further reference to FIGS. 5 to 7, each of the x-axis and y-axis antennas 22, 23 is a loop antenna and includes a plurality of parallel antenna traces 221, 231. Each of the antenna traces 221 of the x-axis antenna 22 is formed on the first surface 211 of the dielectric substrate 21, as best shown in FIG. 5, and extends in a first direction, as best shown in FIG. 6. Each of the antenna traces 231 of the y-axis antenna 23 is formed on the second surface 212 of the dielectric substrate 21, as best shown in FIG. 5, and extends in a second direction transverse to the first direction, as best shown in FIG. 7. In this embodiment, each of the x-axis and y-axis antennas 22, 23 is made from a copper foil provided on the dielectric substrate 21.

The antenna traces 221, 231 of the x-axis and y-axis antennas 22, 23 detects magnetic fields from an electromagnetic pen 35 when the electromagnetic pen 35 makes a point contact with a surface of the LCD panel 31.

The display device 3 further includes a control circuit (not shown) that is mounted on the LCD panel 31, and that translates the magnetic fields detected by the antenna traces 221, 231 of the x-axis and y-axis antennas 22, 23 into coordinates of the electromagnetic pen 35.

The first surface 211 of the dielectric substrate 21 defines a plurality of regions 2111, each of which is bounded by an adjacent pair of the antenna traces 221 of the x-axis antenna 22, as best shown in FIG. 6.

Each of the contact units 24 is formed on the first surface 211 of the dielectric substrate 21, and includes an array of first contacts 2.41 and an array of second contacts 242. Each of the second contacts 242 corresponds to a respective one of the first contacts 241.

The antenna module 2 further includes a plurality of light-emitting diodes 27, each of which is coupled electrically to a corresponding pair of the first and second contacts 241, 242 using surface mount technology (SMT).

It is noted herein that each of the contact units 24 is disposed within a respective one of the regions 2111 of the first surface 211 of the dielectric substrate 21 without overlapping the antenna traces 231 of the y-axis antenna 23. The construction as such prevents the contact units 24 and the light-emitting diodes 27 20 from obstructing the antenna traces 231 of the y-axis antenna 23 in detecting magnetic fields of the electromagnetic pen 35.

The interconnecting unit 25 is formed on the first surface 211 of the dielectric substrate 21, is coupled 25 to a power source (not shown) that supplies electrical power to the light-emitting diodes 27, and includes a plurality of first interconnecting lines 251, each of which interconnects the first contacts 241 of a respective one of the contact units 24, and a plurality of second interconnecting lines 252, each of which interconnects the second contacts 242 of a respective one of the contacts units 24. In this embodiment, each of the first and second interconnecting lines 251, 252 of the interconnecting unit 25 extends in the first direction. The construction as such decreases any undesirable affect that the interconnecting unit 25 may have on the detection of the magnetic fields by the antenna traces 221 of the x-axis antenna 22.

The antenna module 2 further includes a connecting unit 28. In this embodiment, the connecting unit 28 includes first and second electrical connectors 281, 282. The first electrical connector 281 of the connecting unit 28 is coupled electrically to the antenna traces 221, 231 of the x-axis and y-axis antennas 22, 23. The control circuit of the display device 3 is coupled electrically and removably to the first electrical connector 281. The magnetic fields detected by the antenna traces 221, 231 of the x-axis and y-axis antennas 22, 23 are sent to the control circuit of the display device 3 via the first electrical connector 281. The second electrical connector 282 of the connecting unit 28 is coupled electrically to the first and second interconnecting lines 251, 252 of the interconnecting unit 25. The control circuit of the display device 3 is further coupled electrically and removably to the second electrical connector 282. Control signals from the control circuit of the display device 3 are sent through the first and second interconnecting lines 251, 252 of the interconnecting unit 25 via the second electrical connector 282.

As best shown in FIG. 5, the antenna module 2 further includes an electromagnetic interference (EMI) shield 29 attached to the second surface 212 of the dielectric substrate 21 with the use of an adhesive (not shown), thereby covering the second surface 212 of the dielectric substrate 21 and the antenna traces 231 of the y-axis antenna 23 for the purpose of preventing electromagnetic interference. In this embodiment, the EMI shield 29 is in the form of a metallic film that is made from a metal alloy, such as the METGLAS® 2605 SA1 iron-based alloy.

It is noted that, aside from preventing electromagnetic interference, the EMI shield 29 dissipates heat generated by the light-emitting diodes 27.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An antenna module for a display device that incorporates an electromagnetic digitizing tablet function, comprising:
a dielectric substrate has opposite first and second surfaces;
an x-axis antenna including a plurality of parallel antenna traces, each of which is formed on said first surface of said dielectric substrate and extends in a first direction;
a y-axis antenna including a plurality of parallel antenna traces, each of which is formed on said second surface of said dielectric substrate and extends in a second direction transverse to the first direction;
a plurality of contact units, each of which is formed on said first surface of said dielectric substrate and includes an array of first contacts and an array of second contacts; and
an interconnecting unit formed on said first surface of said dielectric substrate, and including
a plurality of first interconnecting lines, each of which interconnects said first contacts of a respective one of said contact units, and
a plurality of second interconnecting lines, each of which interconnects said second contacts of the respective one of said contacts units;
wherein said first surface of said dielectric substrate defines a plurality of regions, each of which is bounded by an adjacent pair of said antenna traces of said x-axis antenna, and
wherein each of said contact units being disposed S within a respective one of said regions.

2. The antenna module as claimed in claim 1, wherein each of said second contacts corresponds to a respective one of said first contacts, said antenna module further comprising a plurality of light-emitting diodes, each of which is coupled electrically to a corresponding pair of said first and second contacts.

3. The antenna module as claimed in claim 1, wherein said contact units are disposed without overlapping said antenna traces of said y-axis antenna.

4. The antenna module as claimed in claim 1, wherein each of said first interconnecting lines of said interconnecting unit extends in the first direction.

5. The antenna module as claimed in claim 1, wherein each of said second interconnecting lines of said interconnecting unit extends in the first direction.

6. The antenna module as claimed in claim 1, further comprising a connecting unit including
a first electrical connector coupled electrically to said antenna traces of said x-axis and y-axis antennas; and
a second electrical connector coupled electrically to said first and second interconnecting lines of said interconnecting unit.

7. The antenna module as claimed in claim 1, further comprising an electromagnetic interference (EMI) shield covering said second surface of said dielectric substrate and said antenna traces of said y-axis antenna.

8. The antenna module as claimed in claim 7, wherein said EMI shield is in the form of a metallic film.
